(19) United States
(12) Patent Application Publication
(10) Pub. No.: US 2026/0278394 A1
(43) Pub. Date: Sep. 17, 2026

(54) BLOCKCHAIN-BASED DEEP NEURAL NETWORK MODEL FEDERATED RECOMBINATION METHOD AND SYSTEM

(71) Applicant: ZHEJIANG UNIVERSITY, Zhejiang (CN)

(72) Inventors: Mingli SONG, Hangzhou (CN); Yi WANG, Hangzhou (CN); Jie SONG, Hangzhou (CN); Zunlei FENG, Hangzhou (CN); Gang CHEN, Hangzhou (CN)

(21) Appl. No.: 19/471,466

(22) PCT Filed: Apr. 28, 2023
(86) PCT No.: PCT/CN2023/091677

§ 371 Date: Oct. 1, 2025

(30) Foreign Application Priority Data
Apr. 11, 2023 (CN) 202310378980.8

(51) Int. Cl. G06N 3/096; G06N 3/098; H04L 9/00

(52) U.S. Cl. CPC G06N 3/096; G06N 3/098; H04L 9/50

(57) ABSTRACT

A blockchain-based deep neural network model federated recombination method includes constructing a consortium blockchain for model federated recombination; configuring a smart contract for the model federated recombination; storing data in a model federated recombination process; training a source model of a model training party, and providing the source model to a model recombination verification party for federated combination; performing model federated recombination, wherein the model recombination verification party performs federated recombination on the source model to obtain a target model; and calculating a contribution value of the model training party. For the reusability of a deep neural network model and the finiteness of computing power and data during single-node user model recombination, multi-node model federated recombination is performed. For the data security and privacy in a federated process and the mutual distrust between multiple nodes in federation, a Hyperledger Fabric-based consortium blockchain and a smart contract are constructed.

### TECHNICAL FIELD

This invention belongs to the field of federated deep learning and blockchain, involving a blockchain-based deep neural network model federated recombination method and system.

### BACKGROUND

Blockchain technology is a distributed database technology, initially developed to support the transactions of the cryptocurrency Bitcoin. The founder of Bitcoin, Satoshi Nakamoto, proposed a decentralized digital currency system using blockchain technology to ensure the security and reliability of transactions. The core of blockchain technology is decentralized data management, differing from traditional centralized data management methods. Blockchain technology stores data on multiple nodes through a distributed network, ensuring the immutability and security of the data.

Recombination deep neural network models is a task of reusing deep neural models. With the rapid development of deep learning, the number of pre-trained deep neural network models online is vast, and reusing pre-trained models can reduce the cost of training new models from scratch. The goal of model recombination is to extract and fuse the knowledge from multiple source models that handle different tasks into a single, compact target model. This is done under the condition that only the source models and their inference outputs are available, and the training data for the source models cannot be accessed. The result is a lightweight target model that can handle all the source tasks with high performance.

Model recombination tasks are currently performed only on single nodes. However, the limited computational power and data of single-node users restrict its further expansion, and the setting for target tasks is relatively narrow. Federated learning methods are built on a foundation of mutual trust among multiple nodes, but this trust cannot be achieved across all nodes in a network. Additionally, the security of data sharing among nodes cannot be guaranteed during the fusion process. Furthermore, federated model recombination requires a fair and reasonable allocation of contributions among the nodes participating in the process.

### SUMMARY OF THE DISCLOSURE

To address the issues mentioned above, this invention provides a blockchain-based federated recombination method and system for deep neural network models.

To solve these problems, this invention proposes a blockchain-based federated recombination method and system for deep neural network models. Recognizing the limited computational power and data of single-node users, this invention introduces a multi-node federated recombination method. By using blockchain technology, the cooperative agreements between multiple nodes are established through a blockchain smart contract. This ensures the security, trustworthiness, and fairness of multi-node collaboration. This leads to the proposed blockchain-based federated recombination method and system for deep neural network models. The technical solution of this invention is as follows:

A blockchain-based federated recombination method and system for deep neural network models, which includes the following steps:
1. Building a consortium blockchain for federated model recombination;

Based on the Hyperledger Fabric framework, a consortium blockchain for federated model recombination is built. This consortium chain is composed of four key roles: consortium members, consortium operators, smart contract auditors, and blockchain developers. Nodes that participate in federated model recombination act as the consortium members. The Hyperledger Fabric framework serves as a foundational structure for a consortium blockchain, providing core functionalities like permission management, ledger maintenance, and smart contracts. Users only need to set up the corresponding business logic. Building on this framework, the business interaction among consortium members is set as federated model recombination. The process begins with a client initiating a task, which is then received by both the model trainers and the model recombination verifiers. These three parties establish a collaboration through a smart contract, thereby creating the consortium blockchain for federated model recombination.
2. Setting up smart contracts for federated model recombination;

Smart contracts are executed automatically based on the agreed-upon terms, facilitating collaboration and accountability among the client, model trainers, and model recombination verifiers. The following are the essential smart contracts for federated model recombination:
1) For the Client:
a) Define the target tasks for model recombination and the acceptance criteria for the final model;
b) Provide probe data for the target tasks (a subset of the target task dataset) to the model recombination verifiers and set the reward for their task;
c) Specify the source models required from the model trainers, set a minimum transferability score for them to participate in the recombination process (Step 5.1), and establish the training rewards. It also ensures that rewards are allocated to model trainers based on the contribution calculation method in Step 6.
2) For the Model Trainers:
a) After the first transferability evaluation by the model recombination verifiers in Step 5.1, model trainers whose models were not selected can choose to exit the task early or continue participating to receive a corresponding reward based on the contribution calculation method in Step 6;
b) Provide the source models for the target tasks to the model recombination verifiers;
3) For the Model Recombination Verifiers:
a) Use the target task probe data to federate and recombine the source models into a target model. They submit the validated target model to the client once it meets the acceptance criteria;
b) Calculate the contribution value for each model trainer using the contribution calculation method in Step 6.
3. Storing Data During Federated Model Recombination;

A Decentralized Storage (DS) system is used to securely share data between the client and model recombination verifiers (probe data and the target model) and between model trainers and model recombination verifiers (source models). This ensures the security of data and private machine learning models. The DS system makes accessing these data and learning models more affordable, faster, and more secure, better meeting the communication needs of the federated learning process. After a node stores data or a private model in the DS system, a unique hash address representing these assets is generated and shared. This guarantees the integrity and authorization of the sharing process. Specifically, we will use the InterPlanetary File System (IPFS) for decentralized storage in the subsequent processes.
4. Training the Model Trainers' Source Models;

The process of federated model recombination is divided into two parts: a source model training task and a federated recombination and validation of the source models to create a target model. These two parts are handled by the model trainers and the model recombination verifiers, respectively. The model trainers provide the source models needed by the verifiers. Source model training consists of two steps: local pre-training and knowledge distillation.

Model trainers use their local data to train a local pre-trained model, denoted as M={M₁, M₂, M_{N}} for the N model trainer nodes. To ensure privacy, knowledge distillation is performed on these local pre-trained models to create the source models that will be provided to the model recombination verifiers for the federated recombination and validation process.

The source models learn knowledge from the local pre-trained models using a feature-based knowledge distillation method. Due to the heterogeneity of the network structures, a translation module is used during knowledge distillation to align the feature output dimensions of the local pre-trained models and the source models. This converts the source model output to a predefined length.

Let

$${T}_{n}^{s} and {T}_{n}^{p}$$

represent the length-aligned features of the source model and the local pre-trained model Mₙ for the n^{th} node, respectively. Let

$${β}_{n}^{t} , {β}_{n}^{p}$$

be the parameters of the n^{th} node's source model and local pre-trained model, respectively, during the t^{th} communication with the model recombination verifiers. X is the training data for model Mₙ. To make the intermediate output of the source model mimic that of the pre-trained model, the feature knowledge distillation loss is calculated as follows:

$$L = \frac{1}{2} {‖ {T}_{n}^{p} ( X ; {β}_{n}^{p} ) - {T}_{n}^{s} ( X ; {β}_{n}^{t} ) ‖}^{2} \qquad ( 1. )$$

Source model parameters are updated using gradient descent as follows:

$${β}_{n}^{t} ← {β}_{n}^{t} - {η}_{t} Δ L \qquad ( 2. )$$

After local knowledge distillation, the source model parameters

$${β}_{n}^{t}$$

are uploaded to tne InterPlanetary File System (IPFS) to serve as the source models for the model recombination verifiers. The verifiers retrieve the model parameters using the unique hash addresses provided by the model trainers.
5. Federated Model Recombination;

The source models obtained in Step 4 undergo federated model recombination by the model recombination verifiers. Since the source models provided by the model trainers are trained on different local data, it's necessary to select the most beneficial models for the target model. Therefore, federated model recombination consists of two steps: (1) source model selection and (2) federated recombination and performance validation.
5.1. Select the favorable models from the source model set for the federal recombination in step 5.2. To measure whether a source model is favorable to the target model, saliency maps are used to measure the transferability of the knowledge contained in the source model, thereby measuring the favorability. Specifically, based on the probe data provided by the client and model requirements, the model recombination verifier first trains to obtain the original target model, calculates the average saliency map of the target model for the probe data, then calculates the average saliency map of each source model for the probe data based on the source models, and computes the transferability score of the source model by pairwise calculation of the two. The formula for calculating the saliency map is as follows:

$${{f}_{n , j}^{k} [ \vert \frac{\partial {Ψ}_{k}}{\partial {x}_{j}} \vert ]}^{{W}_{n} {H}_{n} {C}_{n}} \qquad ( 3. )$$

Among them, Ψₖ represents the implicit feature of the k^{th} layer of the source model, and

$${f}_{n , j}^{k} ∈ {R}^{WHC}$$

represents the saliency map of the k^{th} layer of the source model at the n^{th} node for an input image xⱼ in the probe data D_{T}.

The saliency map of the k^{th} layer of the source model at the n^{th} node for all probe data D_T is denoted as

$${F}_{n}^{k} ,$$

which is obtained by taking the average of all

$${F}_{T}^{k}$$

where S is the total number of images in D_T. The transferability Y_{n,T} between the two models and the normalized selection probability pₙ of the source model can be estimated as follows, where

$${f}_{n , j}^{k} as {F}_{n}^{k} = \frac{1}{S} {\sum }_{j = 1}^{S} {f}_{n , j}^{k} ,$$

is the saliency map of the k^{th} layer of the target model, and

$$I ( {F}_{n}^{k} , {F}_{T}^{k} ) = \frac{{F}_{n}^{k} \cdot {F}_{T}^{k}}{‖ {F}_{n}^{k} ‖ ‖ {F}_{T}^{k} ‖} :$$

$${ϒ}_{n , t} = \frac{I ( {F}_{n}^{k} , {F}_{T}^{k} )}{S} \qquad ( 4 )$$

$${p}_{n} = \frac{{e}^{{ϒ}_{n , T}}}{{\sum }_{b = 1}^{N} {e}^{{ϒ}_{b , T}}} \qquad ( 5 )$$

Based on the selection probabilities of the source models, the top K source models with pₙ not lower than the minimum transferability score set by the client are selected for the recombination update in step 5.2.
5.2. For the source models selected for federal recombination, verify the performance of the target model obtained after recombination. Based on the original target model parameters obtained in the first step 5.1, the source models are federally recombined using a greedy recombination method, so that after each federal recombination of the target model, the target model parameters are updated and the performance of the target model is improved. In the greedy recombination process, first, the source models to be added are verified and tested using the probe data provided by the client. Then, the source model parameters are averaged with the target model parameters in descending order of the verification test performance. The fused target model is again verified and tested based on the probe data. If the performance is improved, the updated target model parameters are retained, and accᵢ is recorded as the value by which the i^{th} source model trainer node improves the target model performance in this iteration. The above operations are repeated for the source models to be added sorted in descending order until completion, which is regarded as one iteration of federal recombination. When the performance of the target model meets the acceptance criteria set by the client, the model recombination verifier uploads the target model to the InterPlanetary File System (IPFS) and provides the client with the corresponding hash address.
6. Calculate the contribution value of the model trainers;

Based on the transferability scores of the source models provided by each model trainer in step 5 and the improvement in the performance indicators of the target model during the federal recombination process, a normalization calculation is performed to obtain the contribution measure of each model trainer to the target model. Let R_{t,i} represent the contribution value of the i^{th} model trainer node between the model trainer and the model recombination verifier in the t^{th} federal communication iteration. The contribution calculation is as follows:

$${R}_{t , i} = α * {acc}_{t , i} + β * {p}_{t , i} \qquad ( 4 )$$

where acc_{t,i} is the performance improvement of the target model caused by the selected source model in step 5.2, p_{t,i} is the transferability score of the selected source model in step 5.1 (if not selected, p_{t,i}=0), and α, β are variable parameters used to adjust the weight ratio of acc_{t,i} and p_{t,i} while unifying their numerical orders of magnitude.

Considering that the performance growth of the target model is approximately a logarithmic nonlinear growth, the contribution values obtained from each iteration cannot be directly accumulated and averaged. Therefore, an exponentially weighted moving average method with bias correction is adopted. As the number of iterations increases, the weight of contribution values from recent iterations is increased, and the weight of contribution values from earlier iterations is reduced. Finally, the cumulative contribution value Eᵢ^{t} of the i^{th} model trainer after t rounds of communication iterations is calculated as follows:

$${E}_{i}^{t} = μ {E}_{i}^{t - 1} + ( 1 - μ ) \cdot {R}_{t , i} \qquad ( 5 )$$

where

$${E}_{i}^{t} = {E}_{i}^{0} = 0$$

when t=0. It Is assumed that each contribution value R_{t,i} is adopted, so the value of μ can be calculated according to the formula t=1/(1−μ). Through the following bias correction, the final contribution value Eᵢ of the it model trainer can be obtained, and the corresponding task reward that the model trainer can obtain is calculated based on the final contribution value Eᵢ. Where B is the total reward for the model training task given by the client, and Bᵢ is the corresponding reward that the i^{th} model trainer can obtain:

$${E}_{i} = \frac{{E}_{i}^{t}}{1 - {μ}^{t}} \qquad ( 6 )$$

$${B}_{i} = \frac{B * {E}_{i}}{{\sum }_{i = 1}^{N} {E}_{i}} \qquad ( 7 )$$

The implementation of the blockchain-based federated recombination method and system for deep neural network models according to the present invention includes an alliance chain module for model federated recombination, a smart contract module for model federated recombination, a distributed storage data sharing module, a source model training module, a model federated recombination module, and a model recombination contribution distribution module.

The blockchain-based federated recombination method and system for deep neural network models first constructs an alliance chain suitable for model federated recombination cooperation tasks based on the Hyperledger Fabric framework. According to the characteristics of model federated recombination tasks, corresponding smart contracts are formulated to determine business logic, establishing a secure and trusted cooperation method among clients, model trainers, and model recombination verifiers. Based on the fast, secure transmission and storage of the InterPlanetary File System (IPFS) as a distributed storage system, the security of data sharing during model federated recombination is further ensured, and the communication transmission requirements during model federated recombination are met. Secondly, model trainers train local pre-trained models based on local data and perform knowledge distillation, with the resulting models serving as source models for the model federated recombination process, ensuring the privacy of pre-trained models while transferring model knowledge. The model recombination verifier selects source models with higher transferability to the target task based on saliency maps. The selected source models are sequentially fused into the target model through a greedy recombination method, with multiple communication iterations until the target model meets the client's acceptance criteria. Finally, based on the contribution calculation method, the transferability scores of the source models provided by model trainers and the improvement in target model performance indicators during the recombination process are normalized to obtain contribution values for each iteration. All iteration contribution values are subjected to exponentially weighted moving average calculation with bias correction to obtain the corresponding final contribution value for each model trainer, which is used as the weight for task reward distribution.

The advantages of the present invention are: Considering the reusability of deep neural network models and the limitations of computing power and data when a single node user performs model recombination, multi-node model federated recombination is conducted. Meanwhile, considering data security and privacy during the federation process and the mutual distrust in cooperation among multiple nodes in the federation, an alliance chain and smart contracts based on Hyperledger Fabric are established to provide a method for secure and trusted cooperation among multiple nodes. The InterPlanetary File System is introduced to ensure data security and privacy. Secondly, the parameter update process of federated recombination uses greedy recombination to ensure stable growth of target model performance while facilitating the calculation of model recombination contributions. Finally, based on the transferability of source models and the improvement in target model performance during model federated recombination, normalization calculation and exponentially weighted moving average calculation with bias correction are used to achieve fair contribution distribution among model trainers.

### BRIEF DESCRIPTION OF THE DRAWINGS

FIG. 1 is a schematic diagram of the blockchain-based federated recombination process for deep neural network models according to the present invention.

FIG. 2 is a schematic diagram of the source model training of the present invention.

FIG. 3 is a schematic diagram of the model federated recombination and performance verification process of the present invention.

### DETAILED DESCRIPTION OF THE EMBODIMENTS

Below, with reference to the accompanying drawings, the technical solution of the present invention will be clearly and completely explained and described, along with a description of its exemplary embodiments. This detailed description should not be considered a limitation of the invention but should be understood as a more detailed description of the application of certain aspects and features of the invention.

The present invention provides a multi-party collaboration method for vehicle detection and classification based on a blockchain-enabled federated recombination method for deep neural network models, which includes the following steps:
1. Building a Consortium Blockchain for Federated Model Recombination;

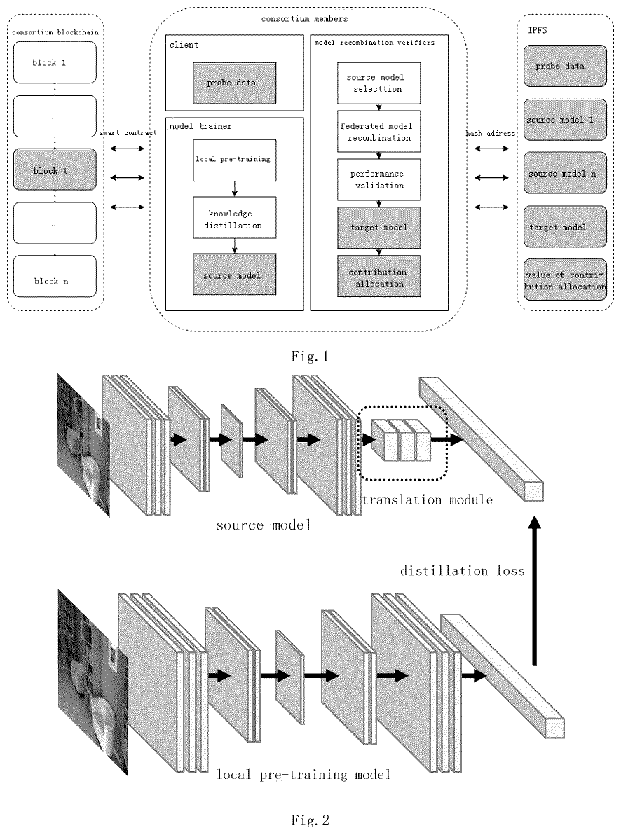

A consortium blockchain that aligns with the collaborative needs of federated model recombination is built based on the Hyperledger Fabric framework. This consortium chain is composed of four roles: consortium members, consortium operators responsible for maintenance and updates, smart contract auditors, and blockchain developers. The nodes participating in the federated model recombination collaboration serve as consortium members. The Hyperledger Fabric framework provides the fundamental structure for a consortium blockchain, offering core technologies such as permission management, ledger maintenance, and smart contracts. Users only need to set up the corresponding business logic. Building on this framework, the business interaction among consortium members is set as federated model recombination. The vehicle detection and classification task is published by the client and is received by the model trainers and the model recombination validators. These three parties establish a collaboration through a smart contract, thereby creating the consortium blockchain for federated model recombination (FIG. 1).
2. Setting Up Smart Contracts for Federated Model Recombination;

Smart contracts are signed among the client, model trainers, and model recombination validators. They automatically execute based on their content, ensuring collaboration and accountability among all three parties. The essential smart contracts for federated model recombination are as follows:
1) For the Client:
a) Define the target tasks for model recombination as vehicle detection and classification and set the final model acceptance criteria;
b) Provide probe data DT for the target tasks (a sampled subset of the vehicle detection and classification image dataset collected by the client) to the model recombination validators and set their task rewards;
c) Specifie the required source models from the model trainers, set a minimum transferability score pthres for them to participate in the recombination process (Step 5.1), and establish the training rewards. It also ensures that rewards are allocated to model trainers based on the contribution calculation method in Step 6.
2) For the Model Trainers:
a) After the first transferability evaluation by the model recombination validators in Step 5.1, model trainer nodes that are not selected can choose to exit the task early or continue to participate and receive a corresponding reward via the contribution calculation method in Step 6;
b) Provide the source models for the target tasks to the model recombination validators;
3) For the Model Recombination Validators:
a) Based on the target task probe data, federates and recombines the source models to create a target model. They submit the validated target model to the client once it meets the acceptance criteria;
b) Calculates the contribution value for each model trainer using the contribution calculation method in Step 6.
3. Storing Data During Federated Model Recombination;

The sharing of probe data and the target model between the client and the model recombination validators, as well as the sharing of source models between model trainers and validators, is implemented through a Decentralized Storage (DS) system. This ensures the security of data and private machine learning model sharing. The DS system makes accessing this data more affordable, faster, and more secure, better meeting the communication needs of the federated learning process. After a node stores data or a private model in the DS system, a unique hash address representing these network assets is generated and shared, which guarantees the integrity and authorization of the sharing process. Specifically, we will use the InterPlanetary File System (IPFS) for decentralized storage in the subsequent processes.
4. Training the Model Trainers' Source Models;

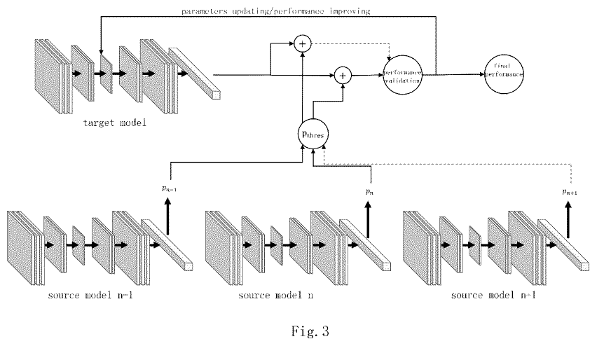

The process of federated model recombination is divided into two parts: a source model training task and the federated recombination and validation of source models to create a target model. The first part is handled by the model trainers, who provide the necessary source models to the model recombination validators. Source model training consists of two steps: local pre-training and knowledge distillation (FIG. 2).

Model trainers use their own local data to train a local pre-trained model, represented as M={M₁, M₂, M_{N}} for the N model trainer nodes. To protect customer data privacy, model trainers cannot access the client's vehicle detection and classification image data. Instead, they must train their local pre-trained models using their own datasets, which have a high relevance to the task. To further ensure the data privacy of the model trainers, knowledge distillation is applied to the local pre-trained models to create the source models that will be provided to the validators for the recombination and validation process.

The source models learn knowledge from the local pre-trained models using a feature-based knowledge distillation method. Because of the heterogeneous network structures, a translation module is used to align the feature output dimensions of the local pre-trained models and the source models. This module converts the source model's output to a predefined length. For example, our translation module uses three convolutions with a 1×1 kernel.

Let

$${T}_{n}^{s} and {T}_{n}^{p}$$

denote the length-aligned features of the source model and the local pre-trained model Mₙ for the n^{th} node, respectively. Let

$${β}_{n}^{t} , {β}_{n}^{p}$$

represent the parameters of the n^{th} node's source model and local pre-trained model, respectively, during the t^{th} communication with the model recombination validators. X is the training data for model Mₙ. To make the intermediate output of the source model mimic that of the pre-trained model, the feature knowledge distillation loss is calculated as follows:

$$L = \frac{1}{2} {‖ {T}_{n}^{p} ( X ; {β}_{n}^{p} ) - {T}_{n}^{s} ( X ; {β}_{n}^{t} ) ‖}^{2} \qquad ( 1 )$$

Source model parameters are updated using gradient descent as follows:

$${β}_{n}^{t} ← {β}_{n}^{t} - {η}_{t} Δ L \qquad ( 2 )$$

After local knowledge distillation, the source model parameters,

$${β}_{n}^{t} ,$$

are uploaded to the InterPlanetary File System (IPFS) to serve as the source models for the model recombination validators. The model recombination validators then retrieve these parameters using the unique hash addresses provided by the model trainers.
5. Federated Model Recombination;

The source models obtained in Step 4 are then subjected to federated model recombination by the model recombination validators. Since the source models provided by the trainers are trained on different local datasets, it is necessary to select the most beneficial source models for the target model. Therefore, federated model recombination involves two steps: (1) source model selection and (2) federated recombination and performance validation (FIG. 3).
5.1. The most beneficial models from the source model set are selected for federated recombination in Step 5.2. To measure a source model's benefit to the target model, a saliency map is used to quantify the transferability of the knowledge it contains. To ensure customer data privacy, the model recombination validators only have access to the target task's probe data (D_{T}), which is a sampled subset of the client's vehicle detection and classification image dataset. Based on the client's model requirements, the validators first train an initial target model and compute its average saliency map on the probe data. They then compute the average saliency map for each source model on the same probe data. The transferability score for each source model is then determined by a pairwise calculation between these two sets of saliency maps. The formula for computing a saliency map is as follows:

$${f}_{n , j}^{k} = {[ \vert \frac{\partial {Ψ}_{k}}{\partial {x}_{j}} \vert ]}^{{W}_{n} {H}_{n} {C}_{n}} \qquad ( 3 )$$

Here, Ψk represents the implicit feature of the source model at layer k, and

$${f}_{n , j}^{k} ∈ {R}^{WHC}$$

represents the saliency map for the k^{th} layer of the source model from the n^{th} node for an input image xⱼ from the probe data D_{T}. In this process, the saliency map is calculated through a single forward and backward pass.

The saliency map for the k^{th} layer of the n^{th} node's source model across all probe data DT is represented by

$${F}_{n}^{k} ,$$

which is obtained by taking the mean of all

$${f}_{n , j}^{k} , i . e . , {F}_{n}^{k} = \frac{1}{S} {\sum }_{j = 1}^{S} {f}_{n , j}^{k} ,$$

where S is the total number of images in D_{T}. The transferability Y_{n,T} between two models and the normalized selection probability pn of the source model can be estimated as follows. Here,

$${F}_{T}^{k}$$

is the saliency map for the k^{th} layer of the target model, and

$$I ( {F}_{n}^{k} , {F}_{T}^{k} ) = \frac{{F}_{n}^{k} \cdot {F}_{T}^{k}}{‖ {F}_{n}^{k} ‖ ‖ {F}_{T}^{k} ‖} :$$

$${γ}_{n , T} = \frac{I ( {F}_{n}^{k} , {F}_{T}^{k} )}{S} \qquad ( 4 )$$

$${p}_{n} = \frac{{e}^{{γ}_{n , T}}}{{\sum }_{b = 1}^{N} {e}^{{γ}_{b , T}}} \qquad ( 5 )$$

To make full use of the implicit features extracted by the models, we use the implicit features of the last layer before the output layer to calculate the saliency map and selection probability. Based on the source model selection probability, the top K source models with a Pₙ value no lower than the minimum transferability score Pₜₕᵣₑₛ set by the client are selected for recombination and updating in Step 5.2.
5.2. The selected source models are used to federate and recombine a target model, and its performance is verified. Based on the initial target model parameters obtained in the first run of Step 5.1, the source models are federated in a greedy recombination approach. This process updates the target model's parameters after each recombination, improving its performance. The greedy recombination process works as follows: First, a new source model is validated using the probe data provided by the client. Then, the parameters of the source models are averaged with the target model's parameters in descending order of their validation performance. The fused target model is then re-validated with the probe data. If the performance improves, the updated target model parameters are kept. The value of this performance improvement is recorded as acc; for the i^{th} model trainer node that improved the target model's performance this time. This process is repeated for the remaining source models in descending order until all are used, completing one iteration of federated recombination. When the target model's performance for vehicle detection and classification reaches the client-set acceptance criteria, the model recombination validators upload the target model to the InterPlanetary File System (IPFS) and provide the client with the corresponding hash address.
6. Calculating the Contribution Value of Model Trainers;

The contribution value for each model trainer is calculated by normalizing the transferability scores of the source models (from Step 5) and the number of performance improvements in the target model during the federated recombination process. Let R_{t,i} be the contribution value of the i^{th} model trainer node in the t^{th} federated communication iteration. The contribution is calculated as follows:

$${R}_{t , i} = α * {acc}_{t , i} + β * {p}_{t , i} \qquad ( 6 )$$

In this formula, acc_{t,i} represents the number of performance improvements made to the target model by the selected source model in Step 5.2. p_{t,i} is the transferability score of the selected source model from Step 5.1. If the source model was not selected, P_{t,i}=0. The variables α and β are adjustable parameters used to weigh the importance of acc_{t,i} and p_{t,i}, and to standardize their numerical scale. For example, if both acc_{t,i} and p_{t,i} are scores between 0 and 1, we can set α=0.8 and β=0.2, which places a higher emphasis on the performance improvement of the target model during each federated recombination iteration.

Since the performance growth of the target model is approximately a non-linear logarithmic increase, it's not possible to directly average the contribution values from each iteration. Instead, we use a bias-corrected exponential moving average method. As the number of iterations increases, this method gives more weight to recent contribution values and less weight to earlier ones. The cumulative contribution value,

$${E}_{i}^{t} ,$$

for the i^{th} model trainer after t communication rounds is calculated as follows:

$${E}_{i}^{t} = μ {E}_{i}^{t - 1} + ( 1 - μ ) \cdot {R}_{t , i} \qquad ( 7 )$$

For t=0.

$${E}_{i}^{t} = {E}_{i}^{0} = 0.$$

Every contribution value R_{t,i} from all rounds is included in the calculation. The corresponding value for u can be determined by the final number of iterations using the moving window size and weight parameter formula,

$$t = \frac{1}{1 - μ} .$$

After applying the following bias correction, the final contribution value, Eₜ, for the i^{th} model trainer is obtained. This final contribution value is then used to calculate the reward that the model trainer will receive:

$${E}_{i} = \frac{{E}_{i}^{t}}{1 - {μ}^{t}} \qquad ( 8 )$$

$${B}_{i} = \frac{B * {E}_{i}^{}}{{\sum }_{i = 1}^{N} {E}_{i}} \qquad ( 9 )$$

Here, B is the total reward value for the model training task provided by the client, and Bᵢ is the reward value that the i^{th} model trainer can receive. With these results, the smart contracts in the consortium blockchain automatically execute. The model trainer nodes that participated in the client's vehicle detection and classification task automatically receive their corresponding rewards. Simultaneously, the model recombination validators receive the specified reward agreed upon in the contract, and the client receives the final target model for vehicle detection and classification.

A system and method for blockchain-based federated recombination of deep neural network models can be implemented by including the following modules: Consortium Blockchain Module for Federated Model Recombination, Smart Contract Module for Federated Model Recombination, Decentralized Data Sharing Module, Source Model Training Module, Federated Model Recombination Module, Model Recombination Contribution Allocation Module.

The specific functions of each module correspond to Steps 1 through 6 of the method described in this implementation.

Recognizing the reusability of deep neural network models and the limitations of computational power and data for single-node users during model recombination, we propose a multi-node federated model recombination collaboration with a corresponding contribution allocation mechanism. To address data security and privacy concerns, as well as the lack of trust between multiple nodes in a federated environment, we have developed a blockchain-based federated recombination method and system for deep neural network models based on the Hyperledger Fabric consortium blockchain and smart contracts. First, a consortium blockchain is built on the Hyperledger Fabric framework to fit the federated model recombination task. Corresponding smart contracts are created to define the business logic, establishing a secure and trusted collaboration among the client, model trainers, and model recombination validators. Simultaneously, the InterPlanetary File System (IPFS) is used as a decentralized storage system to ensure the security of data sharing during the process and to meet the communication requirements of federated model recombination. Next, model trainers use their local data to train and knowledge-distill a local pre-trained model. The resulting model serves as the source model for the federated recombination process. Model recombination validators then use saliency maps to select source models with higher transferability for the target task. The selected models are then progressively fused into the target model using a greedy recombination approach. This process involves multiple communication iterations until the target model meets the client's acceptance criteria. Finally, based on a contribution calculation method, a normalized value for each iteration's contribution is derived from the source models' transferability scores and the performance improvements of the target model during recombination. All iteration contribution values are then combined using a bias-corrected exponential moving average calculation to get each model trainer's final contribution value. This value is used as a weight to allocate task rewards. This invention, by combining blockchain technology with the model recombination method from the field of artificial intelligence, makes a novel attempt in the research area of secure and trustworthy collaborative federated model recombination. It has yielded good results and holds high application value and development potential.

The content described in this specification's embodiments is merely an illustration of the forms of realizing the inventive concept. The scope of protection of the present invention should not be considered limited to the specific forms stated in the embodiments. The scope of protection also extends to equivalent technical means that a person skilled in the art could conceive based on the inventive concept.

1. A blockchain-based federated recombination method for deep neural network models comprising the following steps:
Step 1: building a consortium blockchain for federated model recombination including:
building a consortium blockchain using the Hyperledger Fabric framework to support collaboration for federated model recombination wherein the blockchain is made up of four roles: consortium members, consortium operators (responsible for maintenance and updates), smart contract auditors, and blockchain developers. The nodes that participate in the federated model recombination collaboration serve as consortium members; and
providing, by the Hyperledger Fabric framework, the basic structure for this consortium chain, including key blockchain technologies like permission management, ledger maintenance, and smart contracts. Users simply need to set up the appropriate business logic, wherein on this foundation, the collaboration among consortium members is established as federated model recombination, the client publishes a task, which is received by both the model trainers and the model recombination validators, these three parties agree on a collaboration via smart contracts, which builds the consortium blockchain for federated model recombination;
Step 2: setting up smart contracts for federated model recombination including:
signing smart contracts among the client, model trainers, and model recombination validators, wherein these contracts automatically execute based on their content, ensuring collaboration and accountability among all three parties and guaranteeing security during the federated model recombination process;
Step 3: storing data during federated model recombination including:
handling data sharing between the client and the model recombination validators and between the model trainers and validators by a Decentralized Storage (DS) system, wherein this ensures the security of data and private machine learning models, the DS system makes accessing this data more affordable, faster, and more secure, which meets the communication needs of the federated learning process, after a node stores data or a private model in the DS system, a unique hash address representing that asset is generated and shared, ensuring the integrity and authorization of the sharing process;
Step 4: training the model trainers' source models for federated recombination including:
dividing federated model recombination into two parts: a source model training task and the federated recombination and validation of those source models to produce a target model, wherein the first part is handled by the model trainers, who provide the necessary source models to the model recombination validators. Source model training consists of two steps: local pre-training and knowledge distillation; and
using, by model trainers, their own local data to train a local pre-trained model, represented as M={M₁, M₂, M_{N}} for the N model trainer nodes, wherein to ensure privacy, knowledge distillation is performed on these local pre-trained models to create the final source models, which are then provided to the model recombination validators for the federated recombination and validation process;
wherein the source models learn knowledge from the local pre-trained models using a feature-based knowledge distillation method, due to the heterogeneous nature of the network structures, a translation module is used during the knowledge distillation process to align the feature output dimensions of the local pre-trained models and the source models, converting the source model output to a predefined length. Let
$${T}_{n}^{s} and {T}_{n}^{p}$$
be the length-aligned features of the source model and the local pre-trained model Mₙ for the n^{th} node, respectively, let
$${β}_{n}^{t} , {β}_{n}^{p}$$
be the parameters of the n^{th} node's source model and local pre-trained model during the t^{th} communication with the model recombination validators, X is the training data for model Mₙ, to make the intermediate output of the source model mimic the pre-trained model, the feature knowledge distillation loss is calculated as follows:
$$L = \frac{1}{2} {‖ {T}_{n}^{p} ( X ; {β}_{n}^{p} ) - {T}_{n}^{s} ( X ; {β}_{n}^{t} ) ‖}^{2} \qquad ( 1 )$$
the source model parameters are updated using gradient descent:
$${β}_{n}^{t} ← {β}_{n}^{t} - {η}_{t} ∇ L \qquad ( 2 )$$
after local knowledge distillation, the source model parameters
$${β}_{n}^{t}$$
are uploaded to the InterPlanetary File System (IPFS) to serve as the source models for the model recombination validators, the validators can then retrieve the model parameters using the unique hash addresses provided by the model trainers;
Step 5: by the model recombination validators, federated model recombination on the source models obtained from Step 4 to get the final target model including:
selecting the beneficial models from the set of source models for federated recombination; and
federally recombining the selected source models and validating the performance of the resulting target model;
Step 6: calculating the contribution value of model trainers including:
measuring each model trainer's contribution by normalizing the source model's transferability score from Step 5 and the performance improvement of the target model during the federated recombination process;
letting R_{t,i} be the contribution value of the i^{th} model trainer node in the t^{th} federated communication iteration. The contribution is calculated as follows:
$${R}_{t , i} = α * {acc}_{t , i} + β * {p}_{t , i} \qquad ( 3 )$$
where acc_{t,i} is the amount of performance improvement made to the target model by the selected source model in Step 5.2. P_{t,i} is the transferability score of the selected source model from Step 5.1 (if not selected, p_{t,i}=0), α and β are variable parameters used to adjust the weight ratio and numerical scale of the two parameters, acc_{t,i} and p_{t,i};
using a bias-corrected exponential moving average method to give more weight to the contribution values from recent iterations, wherein the cumulative contribution value,
$${E}_{i}^{t} ,$$
for the i^{th} model trainer after t communication rounds is calculated as follows:
$${E}_{i}^{t} = μ {E}_{i}^{t - 1} + ( 1 - μ ) \cdot {R}_{t , i} \qquad ( 4 )$$
where for t=0,
$${E}_{i}^{t} = {E}_{i}^{0} = 0$$
every contribution value R_{t,i} is used in the calculation, the value of u can be calculated from the formula t=1/(1−μ), after applying the following bias correction, the final contribution value, Eᵢ, for the i-th model trainer is obtained, this value is used to calculate the reward that the model trainer can receive, B is the total reward for the model training task given by the client, and Bᵢ is the reward the i^{th} model trainer can receive:
$${E}_{i} = \frac{{E}_{i}^{t}}{1 - {μ}^{t}} \qquad ( 5 )$$
$${B}_{i} = \frac{B * {E}_{i}}{{\sum }_{i = 1}^{N} {E}_{i}} \qquad ( 6 )$$

2. the blockchain-based federated recombination method for deep neural network models as described in claim 1, wherein setting up smart contracts for federated model recombination includes the following: singing and automatically executing the smart contracts among the client, model trainers, and model recombination validators to establish collaboration and accountability, wherein foundational smart contracts for federated model recombination are as follows:
1) for the Client:
a) establishes the target tasks for federated model recombination and the final acceptance criteria for the resulting model;
b) provides the probe data for the target tasks (a sampled subset of the target task dataset) to the model recombination validators and sets the rewards for their task; and
c) species the source models required from the model trainers, defines the minimum transferability score for them to participate in the recombination process (Step 5.1), and sets the training rewards to be allocated to the model trainers according to the contribution calculation method in Step 6;
2) for the model trainers:
a) after the first transferability evaluation by the model recombination validators in Step 5.1, model trainer nodes whose models were not selected can choose to exit the task early or continue participating to receive a corresponding reward based on the contribution calculation method in Step 6; and
b) provides the source models for the target tasks to the model recombination validators;
3) for the model recombination validators:
a) federally recombines the source models using the target task probe data to obtain the target model. Once the target model meets the acceptance criteria, it is submitted to the client; and
b) calculates the contribution value for each model trainer using the contribution calculation method in Step 6.

3. the blockchain-based federated recombination method for deep neural network models as described in claim 1, wherein
the federated model recombination step involves two parts: (1) selecting beneficial models from the source model set for federated recombination in Step 5.2; and (2) federally recombining the selected source models and validating the performance of the resulting target model;
Step 5.1: selecting beneficial source models for federated recombination in Step 5.2 includes:
to determine if a source model is beneficial to the target model, using a saliency map to measure the transferability of the knowledge it contains, wherein based on the probe data and model requirements provided by the client, the model recombination validators first train an initial target model, they then calculate the target model's average saliency map for the probe data, next they calculate the average saliency map for each source model on the same probe data, the transferability score for each source model is determined by a pairwise calculation between these two sets of saliency maps. The formula for computing a saliency map is as follows:
$${f}_{n , j}^{k} = {[ \vert \frac{\partial {Ψ}_{k}}{\partial {x}_{j}} \vert ]}^{{W}_{n} {H}_{n} {C}_{n}} \qquad ( 7 )$$
where Ψₖ represents the implicit feature of the source model at layer k, and
$${f}_{n , j}^{k} ∈ {R}^{WHC}$$
is the saliency map for the k^{th} layer of the source model from the n-th node for an input image xⱼ from the probe data D_{T};
the saliency map for the k^{th} layer of the n^{th} node's source model across all probe data D_{T} is represented by
$${F}_{n}^{k} ,$$
which is the mean of all
$${f}_{n , j}^{k} :$$
$${F}_{n}^{k} = \frac{1}{S} {\sum }_{j = 1}^{S} {f}_{n , j}^{k}$$
where S is the total number of images in D_{T}, The transferability Y_{n,T} between the two models and the normalized selection probability pₙ of the source model can be estimated as follows
$${F}_{T}^{k}$$
is the saliency map for the target model's k^{th} layer, and
$$I ( {F}_{n}^{k} , {F}_{T}^{k} ) = \frac{{F}_{n}^{k} \cdot {F}_{T}^{k}}{‖ {F}_{n}^{k} ‖ ‖ {F}_{T}^{k} ‖} :$$
$${Υ}_{n , T} = \frac{I ( {F}_{n}^{k} , {F}_{T}^{k} )}{S} \qquad ( 4 )$$
$${p}_{n} = \frac{{e}^{{Υ}_{n , T}}}{{\sum }_{b = 1}^{N} {e}^{{Υ}_{b , T}}} \qquad ( 5 )$$
based on the source model selection probability, selecting the top K source models with a pₙ value no lower than the minimum transferability score set by the client for recombination and updating in Step 5.2;
Step 5.2: federated recombination and performance validation, including
using the selected source models to federate and recombine a target model, and its performance is validated, wherein building on the initial target model parameters from the first run of Step 5.1, the source models are federated in a greedy recombination approach, this process updates the target model's parameters after each recombination, improving its performance, the greedy recombination process works as follows:
a) a source model to be added is first validated using the probe data provided by the client;
b) next, the source model parameters are averaged with the target model's parameters, in descending order of their validation performance;
c) the newly fused target model is then re-validated with the probe data. If its performance improves, the updated parameters are kept;
d) the amount of performance improvement is recorded as acci for the i^{th} source model trainer node; and
e) this process is repeated for the remaining source models in descending order until all are used, which marks the completion of one iteration of federated recombination,
wherein when the target model's performance reaches the client's acceptance criteria, the model recombination validators upload it to the InterPlanetary File System (IPFS) and provide the client with the corresponding hash address.

4. the blockchain-based federated recombination method for deep neural network models as described in claim 1, further comprising using the InterPlanetary File System (IPFS) for decentralized storage during Step 3 and subsequent processes.

5. A system for implementing the blockchain-based federated recombination method for deep neural network models, as described in claim 1, the system comprising consortium blockchain module for federated model recombination; smart contract module for federated model recombination; decentralized data sharing module; source model training module; federated model recombination module; model recombination contribution allocation module, wherein each of these modules corresponds to Steps 1 through 6, respectively, of the method.
